(19) United States
(12) Patent Application Publication
(10) Pub. No.: US 2009/0169109 A1
(43) Pub. Date: Jul. 2, 2009

(54) DEVICE AND PROCESS FOR RECOGNIZING AN OBJECT IN AN IMAGE

(75) Inventors: Hans Grassmann, Duino-Aurisina (IT); Fabiano Bet, Freising (DE)

Correspondence Address: LOGINOV & ASSOCIATES, PLLC, 10 WATER STREET, CONCORD, NH, 03301, US

(73) Assignee: ISOMORPH S.R.L., Duino-Aurisina (IT)

(21) Appl. No.: 12/095,160

(22) PCT Filed: Nov. 28, 2006
(86) PCT No.: PCT/EP2006/011425

§ 371 Date: Sep. 4, 2008

(30) Foreign Application Priority Data
Nov. 29, 2005 (IT) UD 2005 A 000203

(51) Int. Cl. G06K 9/46

(52) U.S. Cl. 382/195

(57) ABSTRACT

The present invention refers to a process and a device for recognizing one or more objects in an image composed by a plurality of pixels. The recognizing of an object in an image comprises at least three phases. In a first phase, a plurality of possible configurations of pixels different therebetween is pre-defined and to everyone of those at least one symbolic coding identifying and describing the features of the corresponding configuration of pixels is associated. In a second phase, the image is processed by means of processing to associate thereto a corresponding sequence of specific configurations detected among said plurality of configurations of pixels in an univocal way. Finally, in a third phase , the symbolic codings associated to the corresponding specific configurations of said sequence are interpreted automatically and correlated therebetween to allow to recognize said object.

### APPLICATION FIELD

The present invention refers to a device and to the related process for recognizing one or more objects in an image. The image, of monochromatic or polychromatic type, for example a photograph, can be acquired by means of a camera, generated by a computer, or derive from an electronic device, such as a sonar or a radar. The object to be recognized can have any form or shape, it can be a full or partially hollow object, it can have a regular or irregular, plane or three-dimensional shape, it can be a human figure or part thereof, an animal or other.

### STATE OF ART

Different techniques for recognizing objects existing in an image by means of processing electronic means, such as the computers, are known.

A first known technique, called “Template Matching”, is based upon a comparison between the geometrical features of the object to be recognized and those of some possible pre-defined combinations (templates), which the object can assume. The recognition is obtained by choosing the pre-defined combination most similar to the object to be recognized. A drawback of such technique is that it is difficult, or even impossible, to define in advance the likeness criterion. Such known technique, in fact, does not allow to recognize exactly the object, but only to associate it to the combination most similar thereto, also involving errors in its recognition. Such known technique is also limited, that is it allows recognizing only and exclusively the objects corresponding to the pre-defined combinations (templates) and therefore it cannot be utilized for recognizing other objects, for example belonging to different types or families.

A second known technique provides an approach of statistical type (Statistical Approach), according thereto each object is represented in terms of a certain number, d, of characteristic parameters defining a vector in a d-dimensional space. The objective of this known technique is to choose such parameters so that the vectors associated to different objects, that is to objects differing therebetween due to one or more of said parameters, occupy separate and distinct regions of the d-dimensional space. Such technique is a posterior procedure, which can be implemented with an algorithm which then has to be able to provide determined output results in presence of determined input conditions. However, up to day, such technique does not guarantee constant output results, which can be satisfying under determined input conditions, but unsatisfying under different conditions.

A third known technique provides a Syntactic Approach and it consists in dividing the object, or pattern, into a plurality of sub-patterns, wherein the elementary sub-patterns are called primitive, which are put in relation therebetween to represent the pattern. What characterizes such technique is the way in which the sub-patterns are put in relation therebetween and the way in which they are translated into symbols. To recognize the pattern, in fact, a formal analogy between the pattern structure and the syntax of a language, the sentences thereof are defined according to a grammar, is defined. However, in the syntactic approach the primitives, or the sub-patterns, are not defined in terms of an absolute position, but of a related position with respect to the other primitives, or sub-patterns, position which can be however defined only with a posterior approach, and which involves then the fact of not being able to associate univocally a determined syntactic structure to an object.

An object of the present invention is to implement a device and to develop a process allowing to recognize an object existing in an image by means of a systematic and universal transition from a numeric representation of the object to be recognized to a symbolic representation, wherein said transition can be carried out in an automatic way by means of calculation, or processing, electronic means, and in a precise and univocal way, without using likeness criteria, or probabilistic or statistical processes typical of the known techniques.

An additional object of the present invention is to implement a device and develop a process allowing associating univocally to the object to be recognized a symbolic representation having features so as to be processed quickly and without the need for using specific computers.

An additional object of the present invention is to implement a device and develop a process allowing to recognize any object, with any shape, size and positioning in space, and not only objects belonging to determined types, or families, of objects as it occurs in the known art.

In order to obviate to the drawbacks of the known art and to obtain these and additional objects and advantages, the Applicant has examined, experimented and implemented the present invention.

### ILLUSTRATION OF THE INVENTION

The present invention is illustrated and characterized in the independent claims. The dependent claims illustrate further features of the present invention or variants of the main solution idea.

According to the above-mentioned objects, a process and a device according to the present invention can be used to recognize an object existing in an image composed by a plurality of pixels.

According to a feature of the present invention, the device comprises processing means and correlation or concatenation means connected to said processing means, for example, of the type based upon a computer.

The processing means and the correlation means are used to carry out the process phases according to the present invention described hereinafter.

In a first phase, a plurality of pixel configurations (templates) different therebetween is defined, each one thereof represents one of the possible configurations which the pixels can assume. In fact, each pixel, which occupies a specific position in the image, can assume a determined condition, that is it can be switched off, switched on or emit a determined light intensity and/or a determined color. A pixel is generally thought of as the smallest complete sample of an image. The definition of a pixel is highly context sensitive. Therefore, depending on the context there are several synonyms that are accurate in particular contexts, e.g. pel, sample, byte, bit, dot, spot, etc. Thus, it has to be noted that when in the following the term pixel configuration is used an abstraction over the several contexts is meant by use of this term. Therefore, for example, also bit configurations are to be understood where appropriate when the term pixel configuration is used in following.

Each different condition of a single pixel will result in a different pixel configuration.

Each pixel configuration can define, for example, a geometrical shape, such as a straight line, a circle, an ellipse, etc., having determined geometrical and/or physical features.

The plurality of configurations can be defined, for example, by the processing means by means of a pre-defined algebraic algorithm and/or stored in storage electronic means, for example of the random access type (RAM) or of the magnetic disk (Hard Disk) type and connected at least to the processing means and/or to the correlation means.

Each pixel configuration is associated to at least one symbolic coding, identifying and describing the features of the corresponding pixel configuration, for example the geometrical and/or physical ones of said geometrical shape, in a univocal way and according to a syntax which can be interpreted and processed by the processing means.

Further, according to the present invention each pixel configuration can be made to be or represent a different address of a memory. Thus, all configurations can be represented and stored in a conventional memory. In this case, a configuration (pre-defined in the first phase) is identified by a sequence of characters (e.g. bit sequence) and this sequence is used univocally as an address of a memory of a memory cell corresponding to the configuration. The symbolic coding identifying and describing the features of the corresponding pixel configuration and associated to this pixel configuration is stored into the memory cell corresponding to the address represented by the corresponding pixel configuration.

Further, according to the present invention, the image can be divided into a plurality of sub-images or groups of pixels. Each of this sub-images is associated to or represent a specific configuration of pixels which in turn is associated to at least one symbolic coding identifying and describing the features of the corresponding configuration. According to the present invention, such a sub-image can be identified univocally by a sequence of characters (e.g. bit sequence) which can be used as an address of a memory cell and corresponds to the corresponding specific configuration.

In a second phase, the processing means processes the image in order to associate thereto, in a univocal way, a corresponding sequence of specific configurations detected in said plurality of pixel configurations.

The association between the image and the sequence of specific pixel configurations can be carried out in different ways, for example by means of a look-up table and/or by means of algebraic algorithms.

In a third phase, the correlation means interprets automatically the symbolic codings associated to the corresponding specific configurations of said sequence, by correlating therebetween, thus allowing recognizing the object.

The invention, therefore, allows associating univocally to the object to be recognized, or to a portion thereof, a symbolic coding, or a message, which identifies it and which describes the features thereof, allowing to carry out a systematic and universal transition from the numeric representation of the object to be recognized to a symbolic representation.

In this way, by means of the symbolic coding, the invention allows recognizing substantially any type of objects.

Furthermore, such association can be carried out quickly and without the need for using specific computers.

According to an embodiment of the invention, during the second phase, the image is divided into a plurality of sub-images, or pixel groups, each one thereof is analyzed, so as to associate thereto a specific pixel configuration. In the third phase, the correlation means interprets automatically the symbolic coding associated to each one of said sub-images and it correlates it, or concatenates it, to the symbolic coding associated to the other sub-images composing the image, for example by means of algebraic algorithms, to define advantageously a symbolic coding associated to the whole image, which can be interpreted by the correlation means to allow to recognize the object.

According to a solution of the invention, in the first phase, each pixel configuration is associated to a memory address of said storage electronic means, which is calculated, for example, in terms of the pixel mutual position and condition in the configuration itself. The symbolic coding related to the configuration is then stored into the memory cell associated to said address.

In the second phase, the image is processed to detect the pixel mutual position and condition, so as to determine univocally the memory address of the corresponding pre-defined configuration, thus allowing correlating in a quick and easy way each sub-image to the corresponding pixel configuration and to the related symbolic coding.

### ILLUSTRATION OF THE DRAWINGS

These and other features of the present invention will become clear from the following description of a preferred embodiment, provided by way of example and not for limitative purposes, by referring to the enclosed drawings, wherein:

FIG. 1 illustrates schematically a device according to the present invention for recognizing an object in an image;

FIG. 2 illustrates schematically an embodiment of the device of FIG. 1 according to the present invention;

FIG. 3 illustrates schematically a variant of a detail of the device of FIG. 2;

FIG. 4 illustrates a pixel configuration defined based upon a first technique according to the invention and stored into an electronic memory of the device of FIG. 2;

FIG. 5 illustrates another pixel configuration stored into the electronic memory;

FIG. 6 illustrates a pixel configuration defined based upon a second technique according to the invention defined by means of the device of FIG. 2;

FIG. 7 illustrates the image including the object to be recognized and a copy image defined based upon a third technique according to the invention;

FIGS. 8, 9 and 10 illustrate three concatenation modes between adjacent pixel configurations;

FIGS. 11, 12 and 13 illustrate a coordinate transformation mode to recognize the object;

FIG. 14 illustrates a mode for recognizing a plurality of objects.

### DESCRIPTION OF A PREFERRED EMBODIMENT

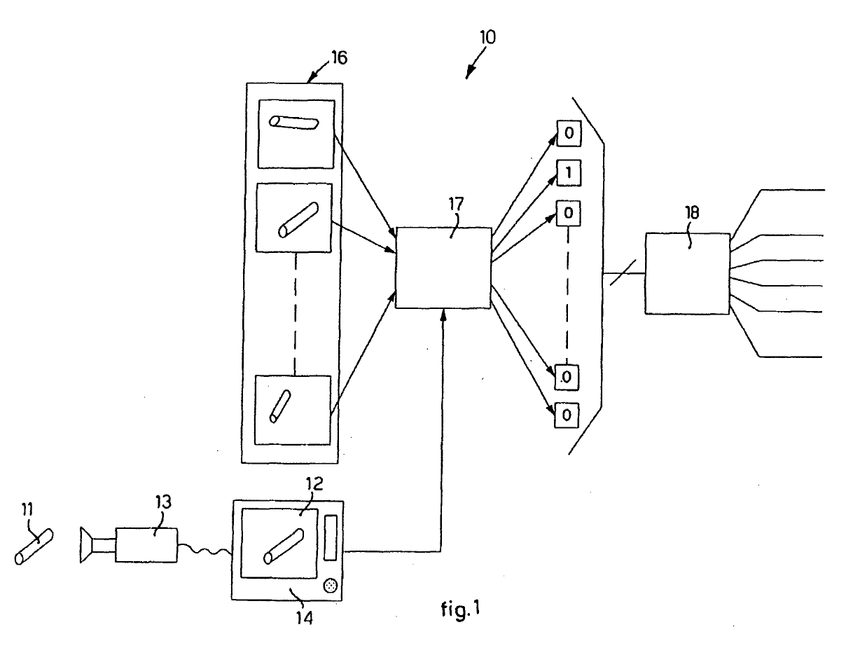

By referring to FIG. 1, a device 10 according to the present invention can be used for recognizing an object, in the specific case, a cylinder, or a tube 11, existing in an image 12.

The device 10 comprises a camera 13, apt to frame the tube 11, a display 14 connected to the camera 13, an electronic memory 16, a comparator 17 and a multiplexer 18.

The camera 13 has a resolution of standard type, for example 500 pixels per line and 1000 pixels per column, that is 500,000 pixels as a whole.

The tube 11 can be wholly defined by six characterizing parameters, which respectively define the length thereof, the diameter thereof, the position in the centre thereof, respectively abscissa and ordinate with respect to a Cartesian coordinate plane, and two angles, azimuth and elevation, respectively.

Each parameter is coded with a resolution of 8 bits. Such resolution is defined in terms of the whole resolution of the camera 13 and it is sufficient to identify with the required preciseness the characteristic parameters.

The six numbers made each one by 8 bits, that is the whole 48 bits, are necessary to describe all possible, different and relevant 2⁴⁸ configurations which the tube 11 can assume and which are stored into the electronic memory 16.

Some of these configurations differ therebetween, for example, due to the only different spatial position of the tube 11, others due to the different sizes of the radius and the length and so on.

Considering that the 2⁴⁸ different configurations of the tube 11 correspond to the different pixel configurations, each of them represents a numerical, or digital, vector of 500,000 bits, in event in which each pixel of the image 12 is coded with a bit.

The comparator 17 is connected both to the electronic memory 16 and to the display 14, or directly to the camera 13, and it has available 2⁴⁸ outputs, each one corresponding to a related configuration stored in the tube.

The comparator 17 is apt to compare the image acquired by the camera 13 with each configuration stored in the electronic memory 16. At the end of the comparison only one of the stored configurations is detected as identical to the tube 11. The comparator 17 associates a respondence value, for example one, to the output corresponding to the detected configuration, whereas it associates a non respondence value, for example zero, to the remaining 2⁴⁸-1 outputs.

The 2⁴⁸ outputs of the comparator 17 are connected to the inputs of the multiplexer 18, which based upon the mutual configuration of the outputs of the comparator 17, provides at its outputs a corresponding signal to said detected configuration and then associated to the particular tube 11 acquired by the camera 13, to its position, etc.

Considering that the possible configurations of the outputs of the comparator 17 are 2⁴⁸, the multiplexer 18 has 48 output channels to define univocally each configuration.

The outputs of the multiplexer 18 are divided into six groups made of 8 outputs, each group defining the respective parameter of the tube (length, diameter, the two centre coordinates, the azimuth and the elevation).

In particular, the multiplexer 18 is pre-configured so that the image 12 which represents the tube 11 having the smallest length value, has a one and seven zeros in the first eight outputs, that is 1000 0000, whereas the tube having a radius value with length immediately greater than the one of the previous radius generates the sequence 0100 0000 in the first eight outputs, and so on for growing radius values and for all other five parameters.

In this way, a symbolic coding is pre-defined which describes univocally the six characterizing parameters, so as to identify univocally the object to be recognized.

The process according to the present invention is described hereinafter in its fundamental phases.

In a first phase, the 2⁴⁸ different configurations of the tube 11 are stored in the electronic memory 16.

Furthermore, in the first phase, the multiplexer 18 is configured, in the way described above, so that each different configuration of the outputs of the comparator 17 is associated to the corresponding configuration of the outputs of the multiplexer 18 defining the corresponding length of the tube 11, its radius, etc.

In a second phase, the comparator 17 compares the tube 11, existing in the image, to each one of the 2⁴⁸ different configurations of the tube 11, in order to look for which configuration corresponds identically to said tube 11.

The comparator 17 carries-out the comparison, pixel by pixel, between the image 12 containing the tube 11 and each configuration stored for the tube.

Only one of the 2⁴⁸ outputs of the comparator 17 has then value one, whereas the remaining 2⁴⁸-1 outputs are set to zero.

In a third phase, the multiplexer 18 processes the signal provided thereto by the comparator 17, by providing the values of the six parameters of the tube 11 to the output.

In this way, the process according to the invention first of all allows recognizing that the object is a tube and then to define all its features in terms of the six parameters.

The invention allows carrying out a recognition by means of transition, or translation from the numeric representation, provided by the camera 13, to a symbolic representation, by means of the correspondence carried out by the multiplexer 18. Mathematically, the 48-bit 2⁴⁸ configurations define a vectorial space and, considering that the device 10 according to the invention allows performing an injective mapping, also the real 248 tubes 11, that is belonging to the real space, form a vectorial space.

As it is known, a Euclidean vectorial space, that is the space wherein the objects are found, for example the tubes 11, and the space of the digital vectors are not isomorphic. However, the Euclidean vectorial sub-spaces of all different and possible 2⁴⁸ positions and sizes of the real tubes 11, and the corresponding 2⁴⁸ configurations of digital vectors, are instead isomorphic. In other words, the input original image and the output symbolic messages are the same messages, but they are expressed in different ways.

The device 10 and the process according to the present invention allow reducing the 500,000 bits, which serve to represent the image, to 48 bits only, without information losses.

The electronic memory 16 comprises 2⁴⁸ cells, and therefore 2⁴⁸ memory addresses, to store the 2⁴⁸ different configurations, each one defined by 500,000 bits. However, such electronic memory 16 cannot be implemented with the current technology.

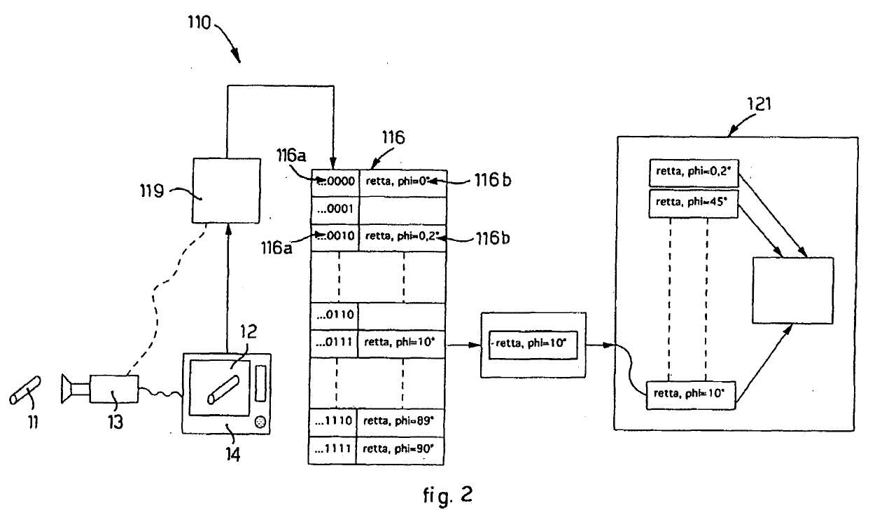

To obviate to this, the image 12 (FIG. 2) acquired by the camera 13 is processed, not as a whole, but sequentially, by means of an embodiment of the device according to the present invention, designated with the number 110.

By way of example three different techniques for processing the image 12 by means of the device 110 are described hereinafter.

To this purpose the device 110 comprises a processing unit 119, for example a computer, connected to a memory 116, and a correlation, or concatenation, unit 121.

According to a first technique, during the second phase, the processing unit 119 divides the image 12 into a plurality of sub-images, or pixel groups. Each sub-image is then compared to all possible configurations 20 which the pixels 22 of such sub-images can assume and which are defined during the first phase.

According to a solution, each sub-image is composed by a square of five times five pixels 22 (FIG. 4).

The choice is suggested by the fact that the memory 116 is of the random type (Random Access Memory, or RAM), which can be currently driven by a 32-bit address bus, which makes available 2³² different addresses. Considering that each pixel 22, in a first approximation, can assume only two values, white or black, which correspond to values zero or one, upon choosing a sub-image of 5*5 pixels 22, the possible different configurations 20 of the pixels 22 of a sub-image are 2²⁵.

Considering that each configuration 20 is made to correspond to a different address 116a of the memory 116, all configurations 20 can be represented and stored in a conventional memory.

However, it is clear that sub-images with different number of pixels 22 and with shapes different from the square can be defined.

In the first process phase, the configurations 20 of 5*5 pixels 22 are defined, each one thereof has a straight line passing through the central pixel 22 and forming a determined angle with a reference to a horizontal straight line, or in other words having a determined angular coefficient, or an angle designated with the symbol □ or phi.

Each configuration 20 of pixel 22 is then identified univocally by means of a 25-bit sequence, formed by five groups of five bits, each group corresponding to a respective line of pixel 22. Each one of the five bits 20 of each group corresponds to a pixel 22 of the line related to that group. Each bit of each group is set equal to the value one if the corresponding pixel 22 is crossed by the straight line, otherwise it is set to zero.

In this way, the configuration 20 of pixel 22 illustrated in FIG. 4 is identified univocally by the sequence 00001 00011 01110 11000 10000. Such sequence can be used as the address 116a of the memory 116 corresponding to such configuration 20, and a symbolic coding 116b is stored into the memory cell corresponding to such address.

The symbolic coding 116b indicates at least characteristic data of the respective straight line, that is it describes that the configuration 20 corresponds to a straight line and it provides at least some properties of the straight line, for example the angular coefficient.

Such operation is repeated for all possible configurations 20 of pixels 22, which represent a straight line, inside a group of 5*5 pixels 22. Then, each one of such configurations 20 is associated to a respective memory address calculated in the way described above is associated , the data related to the configuration 20 itself are inserted into the memory cell thereof. In this way, the invention allows defining a so-called look-up table.

Usually, and in particularly in case of straight lines, the whole number of different relevant configurations is considerably lower than 2²⁵, since no object corresponds to most part thereof. Therefore, only a small part of memory addresses will have relevant data.

All configurations 20 of pixel 22 which do not represent a straight line (FIG. 2) or another pre-defined geometrical shape are associated to memory addresses 116a whose respective cell does not include any symbolic coding.

According to a variant, such cell includes a symbolic coding which underlines the fact that the corresponding configuration 20 does not represent any straight line.

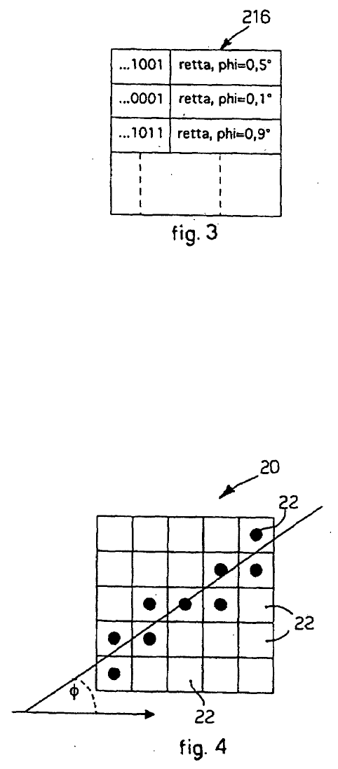

According to another variant illustrated in FIG. 3, the configurations 20 are stored in an electronic memory 216 of associative kind, which can be programmed in a selective way, so that only the symbolic codings corresponding to configurations 20 which represent a straight lines or the pre-defined geometrical shape, are stored.

In general, the same symbolic codings 116b can correspond to different addresses 116a of the memory 116.

During the second process phase, the processing unit 119 acquires the image 12 of the tube 11 to be recognized and it divides it into a plurality of sub-images, each one formed by a square of 5*5 pixels 22.

In case of configurations of 5*5 pixels 22, each pixel 22 of the acquired image 12 can be the centre of a sub-image, except for the pixels 22 of the two more external lines and of the more external columns of the image 12 itself.

Furthermore, in the second phase, the processing unit 119 examines each sub-image, by detecting in each line of pixel 22 the black pixels and the white pixels so as to associate, in the way described above, the sequence of bits defining its address 116a of the memory 116, in the cell thereof the corresponding symbolic coding 116b is stored.

For example, the sequence of bits 00001 00011 01110 11000 10000 provides the following information, stored in the first phase: “This is a straight line passing by the central pixel and forming an angle Φ=40^{o}”.

In the second phase, the process according to the invention allows then to transform a numeric information (the pixel configuration) into a symbolic information (“This is a straight line . . . ”).

The invention allows then to transform a message from a format to another by greatly reducing the length, but without any loss in relevant information.

The Applicant has experimented that, by assigning a resolution of 5 bits to each angle, an image composed by 500,000 pixels (and then 500,000 bits), typically produced 5,000 straight lines and therefore it can be described by 5×5,000=25,000 bits, against the otherwise necessary 500,000 bits.

With a general computer of commercial kind, that is not specifically dedicated to the image recognition and without the need for using vectorial or in parallel processors, each search in the look-up table requires about 1 ns, so that the whole image 12 is scanned in about 500 μs.

It is clear that the configurations 20 of pixels 22 can be defined by a straight line even not passing by the central pixel and also that instead of the straight line other geometrical figures, for example curve lines, ellipses, circles, or still others, can be used, but advantageously apt to generate a bit sequence which identifies it univocally and which can be used, for example, as memory address, in the cell thereof information and properties of the related geometrical shape are stored in advance.

However, the image 12 acquired by the camera 13 has a resolution limited to 500,000 pixels and it has a noise component, for example of electronic type, which shows under the form of one or more pixels with black color, which should be white and/or viceversa.

During the first phase, among the 2²⁵ different configurations 20 also configurations which take into account the possible errors caused by the noise are stored.

For example, let's suppose that the fifth pixel of the first line (00001) (FIG. 4) must be black, but, due to the electronic noise, it is white. In this way, in the first phase, apart from in the address cell 00001 00011 01110 11000 10000, also in the address cell 00000 00011 01110 11000 10000 the information “This is a straight line passing by the central pixel and forming an angle Φ=40^{o}” is stored.

According to another approach, inside a square of 5*5 pixels 22 it is necessary that a certain number of pixels must be white and that such white pixels must occupy determined positions.

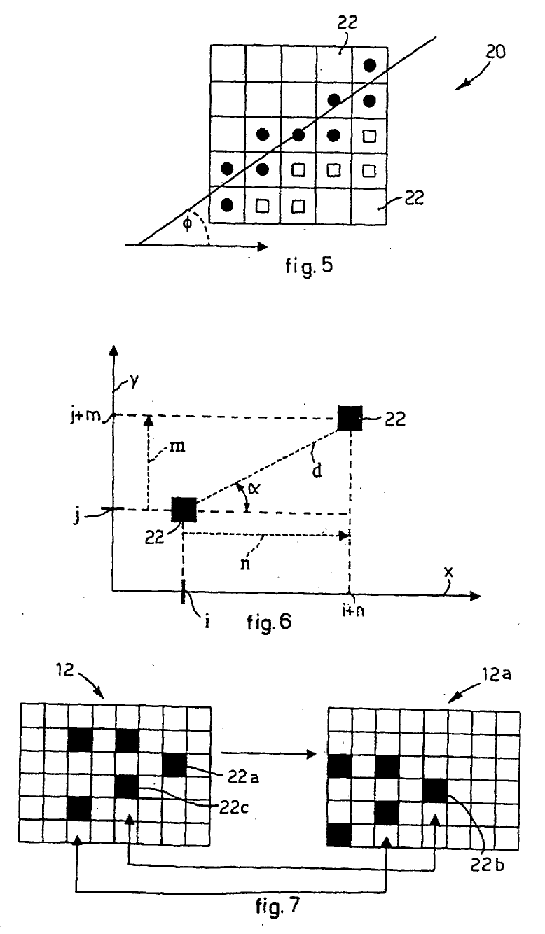

In FIG. 5, the small squares designate the pixels 22 which must be white, whereas all other white pixels can be white or black. In this way, the two sequences of bits 00001 00011 01110 11000 10000 and 01111 00011 01110 11000 10000 are memory addresses the cell thereof includes the same information, for example “This is a straight line passing by the central pixel and forming an angle Φ=40^{o}”. Viceversa, the cell with memory address corresponding to the sequence of bit 00001 00011 01110 11000 11111 does not include a straight line with angle Φ=40° since the second and the third pixel of the last line are black, but they should be white.

Such operations are carried out in the first phase and they allow not only to keep into consideration the limited resolution of the images and the noise presence, but also to detect structures which overlap or which are very near therebetween.

A second processing technique provides to divide the image 12 in sub-images and that the two ends of the straight line segment of FIG. 4 can be used to approximate a straight line. In particular, such pair of pixels 22 has a distance in the horizontal direction and in the vertical one of five pixels.

During the first phase, all configurations of pixels 22 (FIG. 6) arranged at a determined distance d therebetween and defining an angle □ are pre-defined and stored by associating to each one thereof a corresponding symbolic coding.

In the second phase, in each sub-image of the image containing the object to be recognized, all pairs of black pixels having coordinates (i,j) and (i+n, j+m), with n²+m²=d² and with n=d-cos α and m=d·sen α are looked for.

In particular, if n=m=1, during the first phase, the possible configurations of adjacent pixels, or near therebetween, are pre-defined, by associating a corresponding symbolic coding to each one thereof.

During the second phase, in each sub-image, the adjacent 22 pixels are looked for, so as to detect the corresponding configuration.

A third processing technique (FIG. 7) does not imply the need for dividing the image 12 into sub-images, but it allows analyzing the image 12 in its entirety.

In particular, in the second phase the image 12 is copied to define at least one copy image 12a, which is translated by a wished number of pixels 22 with respect to the image 12 according to a pre-defined direction n, m, for example n=2 e m=1.

Such translation moves the pixel 22a of the image 12 by two pixel on the left and by one pixel downwards to define the pixel 22b of the copy image 12a.

Subsequently, the pixels of the copy image 12a are compared to the pixels of the image 12. In particular, the pixel 22c of the image 12 is compared to the pixel 22b of the copy image: if the pixel 22c is black and also the pixel 22b is black, then the pixel 22a of the image 12 defines an extreme of a straight line segment. Analogously, also the other segment extreme is defined.

Such straight line segment has an angle, with respect to a horizontal straight line, equal to the translation angle and a defined length of the distance between the starting point and the ending point.

Furthermore, in the second phase, the corresponding configuration 20 of pixels 22 is associated to the so-detected straight line.

Such operations are repeated to define all the possible straight lines, or straight line segments, of the image 12.

Once each sub-image of the image 12 acquired by the camera 13 has been associated to a corresponding configuration 20 of pixels stored into the electronic memory 16, a plurality of configurations 20 and corresponding symbolic codings correspond to the image 12. During the third phase, the correlation or concatenation unit 121 is apt to couple therebetween the symbolic codings corresponding to such configurations 20 to define pre-defined concatenations 23 to which corresponding symbolic codings, which can be used to recognize the object, are associated.

The coupling procedure of the configurations 20 in pre-defined concatenations 23 can be carried out by means of a look-up table, in a way similar to what described previously, or by means of algebraic algorithms, or with both methods.

In a first sub-phase of the third phase, the correlation unit 121 defines concatenations 23 of adjacent configurations 20 of pixels 22. FIG. 8 illustrates two 20 adjacent configurations, respectively a first configuration 20a, which can be an element of an already defined concatenation 23, or the end of a new concatenation, and a second configuration 20b.

In the first sub-phase the distance d between the central points of the two configurations 20a, 20b is calculated, wherein d is the module of the vectorial sum between the vectors D̅1̅ and D̅2̅ that is . If d=| D̅1̅+ D̅2̅|. If d, | D̅1̅|, or | D̅2̅| is lower than a pre-established value, then the second configuration 20b is then joined as a new element to the concatenation 23.

Alternatively, it is provided to define a search region 24 (FIG. 9) by means of a look-up table. The second configuration 20b is joined to the concatenation 23 if it belongs to the search region 24 defined by the position of the first configuration 20a.

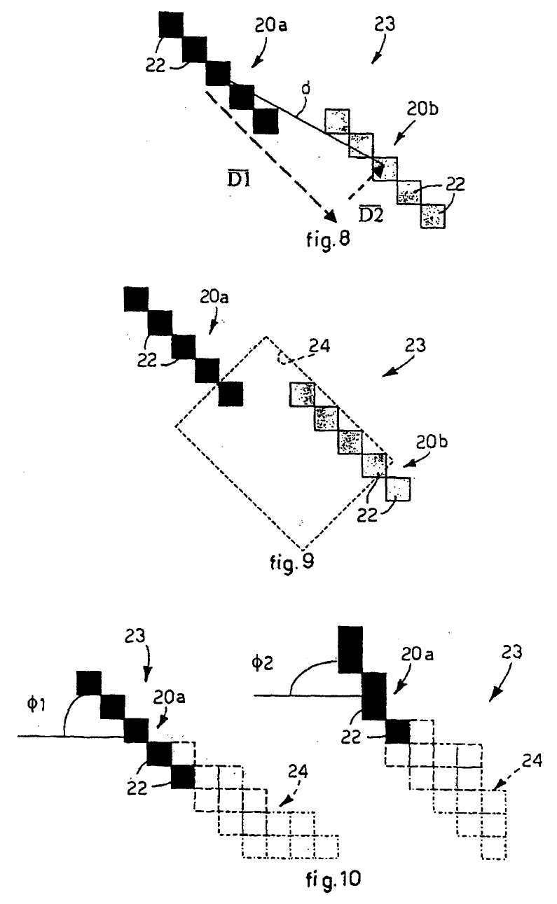

Such search region 24 is rectangular, but it can assume any geometrical shape and position with respect to the first configuration 20a in terms of the search features. For example, (FIG. 10) the search region 24 (drawn with sketched lines) can be defined In terms of the angle Φ, respectively designated with Φ1 and Φ2 in FIG. 10, associated to the first configuration 20a.

In a second sub-phase of the third phase, the geometrical properties of the concatenation 23 are determined, in particular the mutual orientation of the straight line, or straight line segment, between the various configurations 20 of the same concatenation 23 is determined.

In particular, straight lines of adjacent configurations 20 of the same concatenation 23 which have the same angular coefficient 25, at least inside a pre-established precision range, define a straight line having same angular coefficient.

The straight lines of adjacent configurations 20 of the same concatenation 23, which have different angular coefficient, define a curved line, composed by a plurality of broken straight lines each one having a respective angle, or angular coefficient and respective mutual position in the concatenation 23.

The angle Φ and the position D of each straight line are then used to define the different types of curved lines in the concatenation 23. If the distance between the i^{-th} broken straight line and the (i−1)^{-th} broken straight line is designated by d(i), the position of the k^{-th} element of the concatenation 23 is

$$D ( k ) = {\sum }_{i = 1}^{k} d ( i ) .$$

According to an advantageous solution of the invention, in the third phase, a reference system transformation from the Cartesian plane x, y, wherein the concatenations 23 are represented, and the plane D, c is performed.

FIG. 11 illustrates the example of a concatenation 23 which defines a circle in the plane x, y. The circle is transformed into a straight line in the plane D, Φ, the angular coefficient thereof m=tg□ decreases upon increasing the circle radius. In particular, a horizontal line corresponds in the plane D, Φ, to the infinite radius circle, which coincides with a straight line.

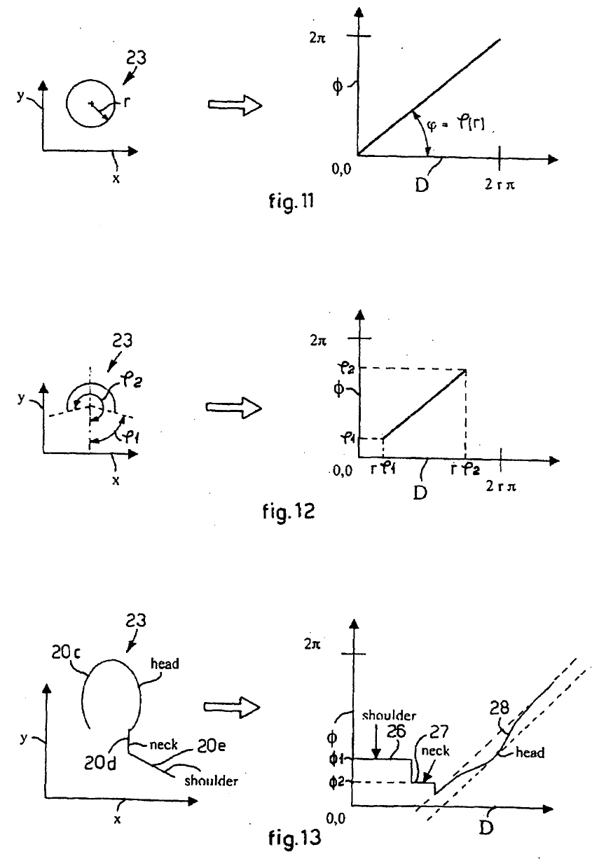

FIG. 12 illustrates a concatenation 23 shaped like a circular sector in the plane x, y which is transformed into a straight line in the plane D, Φ, having a length lower than the line of the complete circle.

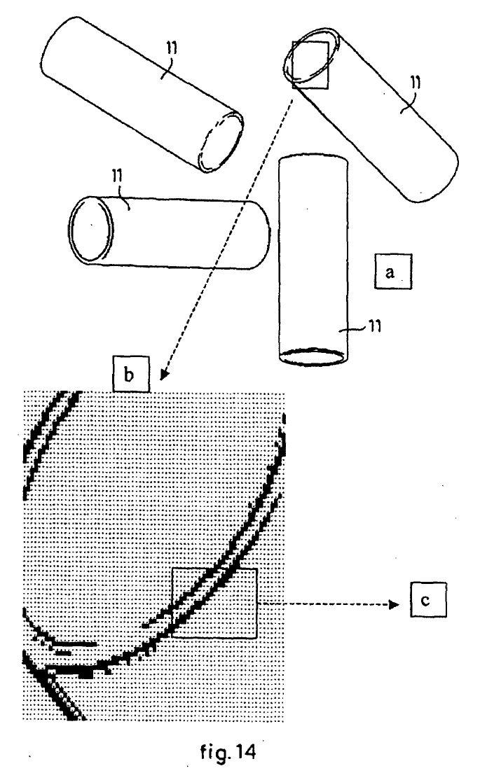

If the concatenation 23 does not define a simple circle, or a sector thereof, but an oval, what is represented in the plane D, Φ, is not a straight line, but a curved line the course thereof deviates from a perfect line the more the oval deviates from the circle. In general, such curved line extends inside the space defined by two parallel straight lines (FIG. 13), the mutual distance thereof defines the oval deviation level from the circle.

If the concatenation 23 is of the type illustrated in FIG. 13, that is it comprises a plurality of configurations associated therebetween and comprising straight lines, ovals, etc., the corresponding representation in the plane D, Φ, includes straight lines or curved lines, which can be easily detected and identified, for example in terms of their absolute position in the plane D, Φ, of the length and the angular coefficient.

In particular, the concatenation 23 comprises an oval 20c therefrom a vertical line 20d departs, connected to an inclined line 20e, respectively defining a human head and the left profile of the neck and the shoulder.

Such concatenation 23 is transformed into a first horizontal straight line 26 with length L1 and angle Φ1, corresponding to the shoulder, a second horizontal straight line 27 with length L2 and angle Φ2, corresponding to the neck and a curved line 28 comprised between the two inclined lines and corresponding to the head.

The object recognition takes place by looking for and re-constructing first of all pre-defined elements, for example the head, the neck and the shoulder, and then by correlating them together to verify if in the related position they really define a head with neck and shoulder.

Thanks to the use of the coordinate transformation the third phase is carried out in a quick way and it can be easily implemented and carried out by a computer also in a wholly automatic way.

From the implementation, or programming, point of view, the second sub-phase of the third phase can be integrated in the first sub-phase of the third phase.

In case the image 12 includes two or more tubes 11 (FIG. 14), or even other objects, the process according to the invention provides a phase wherein each tube 11 is detected. After having detected each tube 11, the already described phases are carried out.

In case the image 12 is composed by colored pixels, the symbolic coding of the geometrical properties 25 of the straight lines can be combined with the information relating the color of the corresponding configuration 20, 20a-20e. In the concatenation process, the color information of the pixels 22 composing the straight line (or the geometrical shape) or of the pixels adjacent to the straight line (or to the geometrical shape) can be used.

In the concatenation forming process, this information can be used, by defining concatenations of straight lines having only one determined color, or a determined combination of colors in the image 12, that is which are arranged proximate pixels 22 having a determined color or a determined color combination, that is which have a determined color or a determined color combination on one side.

Upon recognizing the object by means of the correlation of the concatenations, the information relating the color is used, to define concatenations with geometrical shapes having only a determined color or a determined color combination in the image 12, that is which are arranged proximate pixels 22 having a determined color or a determined color combination.

In case the image 12 is three-dimensional, for example composed by at least two bi-dimensional images acquired by as many cameras 13, during the third phase, the distance between the positions of a determined concatenation of configurations 20, 20a-20e in the various acquired bi-dimensional images is determined.

It is clear to that the changes and/or additions of parts and/or phases can be made to the device 10, 110 and to the process so far described, without departing from the scope of the present invention for this reason.

It is also clear that, although the present invention has been described by referring to some specific examples, a person skilled in the art could surely implement many other equivalent embodiments of devices and processes for recognizing an object into an image, having the features expressed in the claims and therefore all belonging to the protective scope defined by them.

### INDEX

10, 110 device
11 tube
12 image
12a copy image
13 camera
14 display
16, 116, 216 electronic memory
116a memory address
116b symbolic coding
17 comparator
18 multiplexer
20, 20a-20e configuration
22, 22a-22c pixel
23 concatenation
24 search region
26 straight line corresponding to the shoulder
27 straight line corresponding to the neck
28 curved line corresponding to the head
119 processing unit
121 correlation, or concatenation, unit

FIG. 2

straight line

FIG. 3

straight line

1. A process for recognizing an object existing in an image composed by a plurality of pixels comprising:
a first phase, wherein a plurality of possible configurations of pixels different therebetween is pre-defined and wherein to everyone of those at least one symbolic coding identifying and describing the features of the corresponding configuration of pixels is associated;
a second phase, wherein said image is processed by means of processing to associate thereto a corresponding sequence of specific configurations detected among said plurality of configurations of pixels in an univocal way; and
a third phase , wherein, by means of correlations, the symbolic codings associated to the corresponding specific configurations of said sequence are interpreted automatically and correlated therebetween to allow to recognize said object.

2. The process of claim 1 wherein a configuration of pixels pre-defined in said first phase is made to be an address of a memory cell and said at least one coding associated to the configuration of pixels pre-defined in said first phase is stored into said memory cell corresponding to said address represented by said configuration of pixels pre-defined in said first phase.

3. The process of claim 1 wherein during said first phase, said plurality of configurations of pixels is defined by means of pre-defined algebraic algorithms.

4. The process of claim 1 wherein during said first phase, said plurality of configurations of pixels is stored into storage electronic means.

5. The process of claim 1 wherein each one of said configurations of pixels defines at least one respective geometrical shape having determined geometrical and/or physical features.

6. The process of claim 1 wherein said symbolic coding identifies and describes said features in a univocal way and according to a syntax which can be interpreted and processed by said correlation means.

7. The process of claim 3 wherein during said first phase each configuration of pixels is associated to a memory address of said storage electronic means calculated at least in terms of the mutual position and condition of the pixels in the configuration itself.

8. The process of claim 7 wherein the symbolic coding of the corresponding configuration is stored into a memory cell associated to said address.

9. The process of claim 7 wherein during said second phase, said image, or at least one part of said image, is analyzed to detect the mutual position and condition of the pixels, so as to determine the memory address of the corresponding pre-defined configuration.

10. The process of claim 7 wherein during said second phase, said image is divided into a plurality of sub-images, or groups of pixels, each one thereof is associated to a specific configuration of pixels which identifies it in an univocal way.

11. The process of claim 10 wherein a sub-image of said plurality of sub-images is identified univocally by a sequence which can be used as an address of a memory cell corresponding to said specific configuration and wherein at least one symbolic coding associated to said sub-image is stored into said memory cell corresponding to said address.

12. The process of claim 10 wherein during third phase, the at least one symbolic coding associated to one of said sub-images is correlated to symbolic codings associated to the other sub-images composing said image.

13. The process of claim 12 wherein during said second phase, the association between said sub-images and the corresponding configurations of pixels is carried out by means of a look-up table and/or by means of algebraic algorithms.

14. The process of claim 12 wherein during said second phase, by means of said processing means each sub-image of said image is compared to each configuration of pixels of said plurality of configurations.

15. The process of claim 14 wherein during said third phase, the correlation, or concatenation, between said symbolic codings associated to the respective sub-images defines a symbolic coding associated to said image, which can be interpreted by said correlation means to allow recognizing said object.

16. The process of claim 10, wherein during said first phase, a plurality of configurations of pixels is defined, arranged at a determined distance (d) therebetween and defining a straight line having a determined angle (□), by associating to each one thereof a corresponding symbolic coding, and wherein during said second phase, in each sub-image, pairs of pixels having coordinates (i,j) and (i+n, j+m), with n and m being integers and greater than one, are looked for to correlate said sub-image to the corresponding configuration of pixels.

17. The process of claim 1 wherein during said second phase, said image is copied to define at least one copy image, which is translated by a wished number of pixels with respect to said image according to a pre-defined direction (n, m), wherein the pixels of the copy image are compared to the pixels of the image, to define at least the extremes of a line segment, thereto the corresponding configuration of pixels is associated.

18. The process of claim 1 wherein said image comprises at least two objects to be recognized, characterized in that before said second phase, it further comprises a phase wherein said image is analyzed by means of said processing means to detect and isolate each object to be recognized.

19. The process of claim 1 wherein said image is of polychromatic kind, characterized in that during said third phase, the information relating the color of the pixels is analyzed to define concatenations of geometrical shapes characterized by a determined color or by a determined combination of colors in said image, or which are arranged proximate pixels having a determined color or a determined combination of colors.

20. The process of claim 1 wherein said image is of three-dimensional kind and it is defined by at least two bi-dimensional images, characterized in that during said third phase, the distance between the positions of a determined concatenation of configurations in said bi-dimensional images is determined.

21. A device for recognizing an object existing in an image composed by a plurality of pixels comprising:
processing means apt to process said image, so as to associate thereto in an univocal way a corresponding sequence of specific configurations apt to be detected between a plurality of configurations of pixels; the configurations of said plurality being pre-defined and different therebetween and at least one symbolic coding is associated to each one thereof, identifying and describing the features of the corresponding configuration of pixels; and
correlation means apt to interpret automatically and to correlate therebetween the symbolic codings associated to the corresponding specific configurations of said sequence, so as to allow to recognize said object.

22. The device of claim 21 wherein a configuration of pixels being pre-defined is made to be an address of a memory cell and said at least one coding associated to the configuration of pixels being pre-defined is stored into said memory cell corresponding to said address represented by said configuration of pixels being pre-defined.

23. The device of claim 21 wherein said plurality of configurations is apt to be defined by said processing means by means of pre-defined algebraic algorithms.

24. The device of claim 21, wherein it further comprises storage electronic means, connected at least to said processing means, and wherein at least said plurality of pre-defined configurations is apt to be stored.

25. The device of claim 24 wherein said storage electronic means are of the random access type.

26. The device of claim 24 wherein said storage electronic means are of the associative type.

27. The device of claim 21 wherein said processing means are apt to divide said image into a plurality of sub-images, each one thereof is associated to a specific configuration of pixels, which identifies it in an univocal way.

28. The device of claim 27 wherein a sub-image of said plurality of sub-images is identified univocally by a sequence which can be used as and address of a memory cell corresponding to said specific configuration; and wherein at least one symbolic coding associated to said sub-image is stored into said memory cell corresponding to said address.

29. The device of claim 27 wherein said processing means is further apt to interpret in an automatic way the symbolic coding associated to one of said sub-images and to correlate it to symbolic codings associated to the other sub-images composing said image.

30. The device of anyone of the claim 23 wherein said processing means comprise at least one comparator device apt to compare said image to each one of said configurations stored into said storage electronic means, so as to detect only one of the stored configurations.

31. The device of claim 30 wherein said comparator device is apt to carry out, pixel by pixel, the comparison between said image and each stored configuration.

32. The device of claim 30 wherein said comparator device comprises a plurality of outputs, each one corresponding to a respective stored configuration, wherein only the output corresponding to the detected configuration is configured with a respondence value, whereas the other outputs are configured with a non respondence value, distinct from said respondence value.

33. The device of claim 32 wherein said processing means comprises at least one multiplexer device connected to the outputs of said comparator device, apt to configure its own outputs based upon the order according thereto the outputs of said comparator device are configured.

34. The device of claim 33 wherein the outputs of said multiplexer device are divided in groups, each group defining at least one respective parameter characterizing said object.

35. (canceled)
